(19) United States
(12) Patent Application Publication
(10) Pub. No.: US 2004/0110079 A1
(43) Pub. Date: Jun. 10, 2004

(54) Electrostatic latent image developing toner and image forming method

(76) Inventors: Asao Matsushima, Tokyo (JP); Hiroshi Yamazaki, Tokyo (JP); Michiaki Ishikawa, Sagamihara-shi (JP)

Correspondence Address: MUSERLIAN AND LUCAS AND MERCANTI, LLP, 475 PARK AVENUE SOUTH, NEW YORK, NY, 10016, US

(21) Appl. No.: 10/717,388

(22) Filed: Nov. 19, 2003

(30) Foreign Application Priority Data
Nov. 21, 2002 (JP) JP2002-337842

(51) Int. Cl. G03G 9/08

(52) U.S. Cl. 430/110.4; 430/124

(57) ABSTRACT

An electrostastic latent image developing toner is disclosed. The toner comprises colored particles and an external additive, and in which the volume average particle diameter of the toner is 4.0-8.0 μm and the ratio of particles of at most 2.5 μm is 0.1-10 percent by volume. An image forming method employing the toner is also disclosed.

### TECHNICAL FIELD OF THE INVENTION

The present invention relates to an electrostatic latent image developing toner which is employed in image forming apparatuses such as copiers and printers, and an image forming method using the same.

### BACKGROUND OF THE INVENTION

In image forming apparatuses which produce high quality images at a high speed, mostly employed is a system in which electrostatic images are developed employing toner. An Image forming method employing a system in which electrostatic latent images are subjected to toner development is demanded to achieve further higher image quality.

The quality of toner images is very effectively improved by decreasing the size of toner particles. Based on this fact, proposals have been presented to control the size distribution with regard to various toners of smaller diameter.

However, toner comprised of small diameter particles is easily affected by Van der Waals force as well as electrostatic force due to the small diameter. Due to this, adhesion of toner to an electrostatic latent image forming body (in almost all cases, being an electrophotographic photoreceptor or also referred to simply as a photoreceptor), whereby filming on the photoreceptor or degradation of transferability tends to result. Further, toner particles tend to aggregate due to the large adhesion force between particles. As a result, it is desired that required fluidity of toner is secured. In toner comprised of small diameter particles, in order to provide fluidity and to improve transferability, a large amount of external additives are employed.

Specifically, in the formation of color images which requires high image quality, in many cases, an image forming method is employed in which a toner image formed on a photoreceptor is transferred onto an intermediate transfer body, further transferred onto an image support such as paper and then fixed. In such a case, a decrease in diameter of particles degrades transferability of toner. As a result, in the image forming method utilizing an intermediate transfer body system which requires at least two repetitions of the transfer process, problems such as non-uniform transfer and the like tend to result.

On the other hand, there is a method in which without using an intermediate transfer body, toner images of a plurality of colors are formed on the photoreceptor, and the resulting toner images are simultaneously transferred onto an image support such as paper. However, when toner comprised of particles of smaller particle diameter is employed, image quality itself is improved. However, problems tend to occur in which formed images tend to degrade due to the use of a developer over an extended period of time.

In any of these system, these problems tend to result in the form of halftone non-uniformity and fixation staining.

Heretofore, few inventions have been disclosed in which particle diameter of toner as well as a particle size distribution is specified and the addition of external additives is considered.

For example, Japanese Patent Publication Open to Public Inspection (hereinafter referred to as JP-A) No. 2001-166526 discloses a toner in which hydrophobic silica is added in an amount of 0.5-2 percent by weight, the volume average particle diameter is 7-10 μm, and the number distribution of toner particles of a diameter of at most 2 μm in the toner particle mixture is at most 5 percent. This technique refers to a decrease in the number of toner particles in the number distribution. However, no techniques are disclosed with regard to release of external additives from the toner particles, and the resulting effects are not considered. Further, JP-A 2000-10342 discloses a non-magnetic single component toner in which the ratio of particles of weight average particle diameter of at most 2 μm among the particles of weight average particle diameter of 4-10 μm is at most 40 percent by number. However, no description is given with regard to the existing state of external additives and no suggestion is made with regard to effects due to their release.

Various techniques are known which enable external additives to securely adhere onto toner particles. However, techniques are not known which specify the state in which external additives which are not securely adhered are present in a certain amount. Further, no suggestions have been made with regard to effects of toner of a minute particle diameter.

(Patent Document 1)

JP-A No. 2001-166526

(Patent Document 2)

JP-A No. 2000-10342

### SUMMARY OF THE INVENTION

An objective of the present invention is to provide an electrostatic latent image developing toner which is capable of forming high quality images at a high rate, results in no toner filming on an electrostatic latent image forming body (being a photoreceptor), as well as in excellent transferability, and is capable of forming images without unevenness, as well as an image forming method using the same.

The present invention, as well as the embodiments thereof, will now be described.

1. An electrostatic latent image developing toner which comprises colored particles, comprising a resin and a colorant, and external additive particles, wherein a volume average particle diameter of the toner is 4.0-8.0 μm and a sum of the colored particles and the external additive particles having particle diameter of at most 2.5 μm is 0.1-10 percent by volume based on the sum of the colored particles and the external additive particles.

2. The electrostatic latent image developing toner of item 1 wherein the sum of the colored particles and the external additive particles having particle diameter of at most 2.5 μm is 0.3-8 percent by volume based on the sum of the colored particles and the external additive particles.

3. The electrostatic latent image developing toner of item 1 wherein the external additive particles having particle diameter of at most 2.5 μm is 0.5-5 percent by volume based on the sum of the colored particles and the external additive particles.

4. The electrostatic latent image developing toner of item 1 wherein colored particles having particle diameter of at most 2.5 μm is 9 percent or less by volume based on the colored particles.

5. The electrostatic latent. image developing toner of item 4 wherein colored particles having particle diameter of at most 2.5 μm is 0.05-8 percent by volume based on the colored particles.

6. The electrostatic latent image developing toner of item 1 wherein the external particles having particle diameter of at most 2.5 μm is 5 percent or less by volume based on the external additive particles.

7. The electrostatic latent image developing toner of item 3 wherein the external particles having particle diameter of at most 2.5 μm is 0.05-5 percent by volume based on the external additive particles.

8. The electrostatic latent image developing toner of item 1, wherein

colored particles of at most 2.5 μm is 9 percent or less by volume based on the colored particles,

external additive particles having particle diameter of at most 2.5 μm is 0.05-5 percent by volume based on the external additive particles, and

a volume average particle diameter of the toner is 4.0-8.0 μm and sum of the colored particles and the external additive particles of at most 2.5 μm is 0.1-10 percent by volume based on the sum of the colored particles and the external additive particles.

9. An image forming method comprising steps of:

electrically charging a photoreceptor;

imagewise exposing the photoreceptor so that a latent image is formed on the photoreceptor; and

developing the latent image with toner so that a toner image is formed on the photoreceptor;

transferring the color image on the photoreceptor to a image supporting material, and

fixing the transferred color image,

wherein the method employs a toner as itemed in item 1, and a toner image formed on an image support is fixed employing a contact heating system.

10. An image forming method comprising steps of:

electrically charging a photoreceptor;

imagewise exposing the photoreceptor so that a latent image is formed on the photoreceptor; and

developing the latent image with toner so that a toner image is formed on the photoreceptor;

transferring the color image on the photoreceptor to an intermediate transfer body,

transferring the color image on the intermediate transfer body to an image supporting material, and fixing the transferred color image,

wherein the method employs a toner as described in item 1.

11. A method of forming a toner image, comprising steps of:

(a) forming a color image on a photoreceptor by repeating steps of, employing a toner having a different color in each step:

electrically charging a photoreceptor;

imagewise exposing the photoreceptor so that a latent image is formed on the photoreceptor; and

developing the latent image with toner so that a toner image is formed on the photoreceptor;

(b) transferring the color image on the photoreceptor to a image supporting material, and

(c) fixing the transferred color image,

wherein each toner is a toner as described in item 1.

12. A method of forming a toner image, comprising steps of:

(a) forming a color image on an intermediate transfer body by repeating steps of, employing a toner having a different color in each step:

electrically charging a photoreceptor;

imagewise exposing the photoreceptor so that a latent image is formed on the photoreceptor; and

developing the latent image with toner so that a toner image is formed on the photoreceptor;

transferring the toner image on the photoreceptor to the intermediate transfer body,

(b) transferring the color image on the intermediate transfer body to a image supporting material, and

(c) fixing the transferred color image on the image supporting material,

wherein each toner is a toner as described in item 1.

An image forming method wherein a toner image formed on an image support is fixed preferably by employing a contact heating system in one embodiment of the invention.

In another embodiment of the invention, an electrostatic latent image is formed by image exposure, a toner image visualized employing a developer comprising toner is transferred onto an intermediate transfer body, thereafter is transferred onto an image support, and the toner image on the image support is fixed.

### BRIEF DESCRIPTION OF THE DRAWING

FIG. 1 is a sectional view showing the structure of the color image forming apparatus which exhibits one embodiment of an image forming apparatus employed in the present invention.

### DETAILED DESCRIPTION OF THE INVENTION

It was discovered that in a minute diameter particle toner, the presence of a small diameter component markedly affected stability of images.

In the present invention, the ratio of particles of at most 2.5 μm is customarily 0.1-10 percent by volume, is preferably is 0.3-8 percent by volume, and is more preferably 0.5-5 percent by volume.

By incorporating small diameter components of a particle diameter of at most 2.5 μ in a certain amount, insufficient fluidity and transferability which occur, when toner of a small diameter such as an average particle diameter of 4-8 μm is used, are improved, a photoreceptor results in neither filming nor adhesion of external additives after the use over an extended period of time, whereby it is possible to form consistent images for an extended period of time.

The reason for the above phenomenon has not yet been clarified. However, it is assumed to be as follows. By incorporating particles of at most 2.5 μm in a definite amount, the aforesaid particles exhibit a so-called spacer effect, whereby it is possible to decrease adhesion force of toner onto the photoreceptor. As a result, transferability is improved. Further, the presence of the aforesaid type of toner is capable of minimizing adhesion of toner itself onto the photoreceptor, and simultaneously, it is possible to provide an effect which polishes the photoreceptor. Further, effects are also provided which scrape off materials which adhere onto the photoreceptor.

Particles of at most 2.5 μm are very small. As a result, such small particles are easily scattered from the development unit and cause staining in the interior of a color image forming apparatus. As a result, it was discovered that when the added amount of toner was increased excessively, scattering of particles was caused.

Namely, when the amount of particles of at most 2.5 μm exceeds 10 percent by volume, the scattered amount increases quickly and results in staining on the charging member as well as staining on the transfer member. As a result, white streaking problems occur due to insufficient charging as well as insufficient transfer.

On the other hand, with regard to staining in the fixing section, detailed analysis was performed in the same manner as above. As a result, it was discovered that whole staining was not formed only due to the thermal characteristics of the toner and further, adhesion of small diameter components functioned as a trigger. Namely, the small diameter components exhibit relatively large electrostatic adhesion properties. As a result, in addition to thermal adhesion, electrostatic adhesion occasionally results. Further, the small diameter components easily fuse due to their small heat capacity and fuse onto a contact type heating type fixing member. As a result, it was assumed that stains accumulated, resulting in image problems.

Further, in the case of an intermediate transfer system in color image formation, problems occur in which transfer is not easily carried out due to high adhesion properties of small diameter components of toner. It is then assumed that adhesion properties to a photoreceptor differ between positions near the photoreceptor and positions away from the aforesaid positions. As a result, it was assumed that uneven transfer to the intermediate transfer body occurs. Specifically, it was discovered that a major problem occurred in which the toner particles of at most 2.5 μm were transferred.

Further, in the case of a one pass transfer system in which multicolor images are formed on the photoreceptor and are transferred onto an image support such as paper through a single contact, almost the same problems as above occur. Therefore, by regulating the amount of toner particles of at most 2.5 μm, specifically in the intermediate transfer system or the single pass transfer system, it is possible to carry out stable image formation over an extended period of time.

On the other hand, when the ratio of particles of at most 2.5 μm decreases to less than 0.1 percent by volume, it becomes impossible to result in effects such as provided fluidity due to small diameter components, whereby a so-called filming phenomenon tends to occur.

The present invention and the embodiments thereof will now be further described.

<Particles of a Diameter of at Most 2.5 μm>

In the present invention, toner in which the ratio of particles of a diameter of at most 2.5 μm is 0.1-10 percent by weight is defined as follows.

Namely, the ratio of colored particles (being toner particles which have not yet been mixed with external additives) is determined in such a manner that the ratio of particles of at most 2.5 μm is determined based on FPIA in terms of percent by number which is converted to a value (A) in terms of percent by volume. On the other hand, toner comprising external additives is sieved employing a 400-mesh sieve. The difference in the amount of external additives between prior to and after sieving is determined in terms of percent by weight. The resulting difference is converted to a percentage by volume based on specific gravity, which is designated as (B). In the present invention, the sum of “A+B” is designated as percent by volume of particles of at most 2.5 μm.

It is possible to determine the amount of external additives utilizing a calibration curve obtained, for example, by fluorescent X-ray spectroscopy. (B) is calculated based on the difference between the contents prior to and after the sieving process.

The proportion of external additives of at most 2.5 μm is preferably 0.05-5 percent by volume with respect to the total volume of external additives. In such a case, it is possible to make the external additives easily releasable from colored particles, to maintain the desired fluidity of toner itself, and to stabilize charging properties. Further, since it is possible to exhibit the spacer effect, it is possible to improve transferability.

The proportion of colored particles of at most 2.5 μm is preferably 0.05-8 percent by weight with respect to the total volume of colored particles. Since colored particles themselves do not function to provide fluidity, it is assumed that no small diameter components are preferably incorporated. However, it was discovered that some incorporation was capable of exhibiting effects such as maintaining of chargeability and improvement of transferability. Further, it is possible to minimize non-transferred colored particles and the formation of particles which are not easily removed. As a result, filming on the photoreceptor and formation of black spots are minimized.

Methods for controlling the content of colored particles of at most 2.5 μm are not particularly limited. For example, it is possible to control the content employing classification operation. A crushing method is not preferred because minute particles formed by fracturing tend to result. Preferred is a so-called polymerization method, especially a coalescing method in which resinous particles are aggregated (salted out) and fused in a water based medium. In this method, since minute particles are fused in a water based medium utilizing physicochemical energy, it is possible to minimize the formation of minute particles.

In such a case, especially an emulsion polymerization coalescence type, it is more preferable to use multivalent ions.

Preferably employed as multivalent ions are those in the form of salts of divalent metals such as aluminum or magnesium.

It is also possible to list a method which controls coalescence conditions in the water based medium. Namely, in the case of performing salting-out/fusion, it is possible to control the particle size distribution by extending the time after adding salting-out agents. By providing a relatively long extension of the time after salting-out, it is possible to completely coalesce resinous particles and colorant particles. As a result, it is assumed that it may be possible to decrease the amount of minute particles.

On the other hand, in order to control particle size distribution, it is preferable to increase the adhesion force of external additives to colorant particles. To achieve this, a method is preferred in which conditions are controlled for mixing the external additives with the colorant particles. Further, a method is also preferred in which employed external additives are comprised of highly adhesive, i.e., easily charged particles.

In order to mix external additives with colorant particles, it is possible to use high speed stirrers such as a Henschel mixer or a Redige mixer. It is possible to preferably control the adhesion state of the external additives to the colorant particles.

In the case of preparing toner of the present invention employing a Henschel mixer, when external additives comprised of small particles of a number average diameter of the primary particles of at most 50 nm are employed, incorporation of the external additives is enhanced using high speed mixing. As a result, it becomes difficult to prepare toner in the range specified by the present invention. Due to this, a two-stage mixing method is preferred in which high speed mixing is carried out at the initial stage and subsequently, low speed mixing follows. In the aforesaid method, during the initial high speed stirring stage, external additives of a small particle diameter are crushed and are simultaneously dispersed into colorant particles. Thereafter, low speed mixing follows. The aforesaid method is preferred because it is possible to carry out uniform mixing as well as uniform adhesion in a state in which stress applied to the toner is decreased.

In such a case, high speed mixing, as described herein, refers to the peripheral speed of the leading edge of a Henschel mixer of at least 40 m/second, while low speed mixing, as described herein, refers to the same of less than 40 m/second. In addition, it is preferable that the difference in the peripheral speed between high speed stirring and low speed stirring is set to be at 5 m/second or more.

(External Additives)

External additives are preferably comprised of minute particles of a number average particle diameter of 5-1,500 nm.

The number average diameter of the primary particles is determined in such a manner that 1,000 particles are observed by a factor of 2,000, employing a transmission type electron microscopes, and the Fere direction average diameter is determined.

Composition materials may be any of minute inorganic particles, minute organic particles, and minute composite particles prepared by securely adhering minute inorganic particles onto the surface of minute organic particles.

Suitably employed as materials composing minute inorganic particles are various inorganic oxides, nitrides, and borides. Examples include silica, alumina, titania, zirconia, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, and boron nitride. Further employed may be those which are prepared by applying a hydrophobic treatment to the aforesaid minute inorganic particles. When a hydrophobic treatment is carried out, listed may be hydrophobic treatment agents such as titanium coupling agents, silane coupling agents, and fatty acids and metal salts thereof.

Listed as agents for achieving such a hydrophobic treatment are, for example, titanium coupling agents such as tetrabutyltitanate, tetraoctyl titanate, isopropyl triisostearoyl. titanate, isopropyl tridecylbenzenesulfonyl titanate, or titanium bis(dioctylpyrophosphate)oxyacetate as well as silane coupling agents such as γ-(2-aminoethyl)aminopropyltrimethoxysilane, γ-(2-aminoethyl)aminopropylmethyldimethoxysilane, γ-methacryloxypropyltrimethoxysilane, N-β-(N-vinylbenzylaminoethyl)γ-aminopropylmethoxysilane hydrochloric acid salts, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, or p-methylphenyltrimethoxysilane.

Listed as fatty acids and their metal salts are long chain fatty acids such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, or arachidonic acid, and listed as their metal salts are salts of metals such as zinc, iron, magnesium, aluminum, calcium, sodium, or lithium.

Listed as silicone oils may be dimethylsilicone oil, methylphenylsilicone oil, and amino-modified silicone oil.

The aforesaid hydrophobic treatment agents are added to minute inorganic particles in an amount of 1-10 percent by weight and preferably 3-7 percent to cover the aforesaid particles. Further, these may be used in combinations.

Listed as minute organic particles may be styrene resinous particles, styrene-acryl resinous particles, polyester resinous particles, and urethane resinous particles.

Preferred as minute organic particles are vinyl based minute organic particles. Listed as specific examples may be minute organic particles comprised of polymerized resins employing monomers including styrenes such as styrene, α-methylstyrene, p-chlorostyrene, 3,4-dichlorostyrene, p-phenylstyrene, p-ethylstyrene, 2,4-dimethylstyrene, or p-t-butylstyrene or styrene derivatives; methacrylic acid ester derivatives such as methyl methacrylate, ethyl methacrylate, n-butyl methacrylate, isopropyl methacrylate, or 2-ethylhexyl methacrylate; acrylic acid ester derivatives such as methyl acrylate, ethyl acrylate, isopropyl acrylate, n-butyl acrylate, t-butyl acrylate, isobutyl acrylate, n-octyl acrylate, or 2-ethylhexyl acrylate; olefins such as ethylene, propylene, or isobutylene; halogen based vinyls such as vinyl chloride, vinylidene chloride, vinyl bromide, vinyl fluoride, vinylidene fluoride; vinyl esters such as vinyl propionate or vinyl acetate; vinyl ethers such as vinyl methyl ether or vinyl ethyl ether; vinyl ketones such as vinyl methyl ketone, vinyl ethyl ketone, or vinyl hexyl ketone; N-vinyl compounds such as N-vinylcarbazole, N-vinylindole, or N-vinylpyrrolidone; vinyl compounds such as vinylnaphthalene or vinylpyridine; and acrylic acid or methacrylic acid derivatives such as acrylonitrile, methacrylonitrile, acrylamide, N-butylacrylamide, N,N-dibutylacrylamide, methacrylamide, N-butylmethacrylamide, or N-octadecylacrylamide. Incidentally, these vinyl based monomers may be employed individually or in combinations.

It is possible to prepare minute resinous particles employing an emulsion polymerization method or a suspension polymerization method.

It is also possible to use composite minute particles in which minute inorganic particles are securely adhered onto the surface of minute resinous particles.

The aforesaid composite minute particles are prepared as follows. An ordered mixture is prepared by adding minute inorganic particles to the aforesaid minute resinous particles during mixing. After electrostatically adhering minute inorganic particles onto the surface of the minute resinous particles, the minute inorganic particles are securely adhered onto the surface of the minute resinous particles under application of mechanical energy. Adhesion, as described herein, refers to the state in which the adhesion ratio, described in JP-A No. 4-291352 is at least 25 percent.

Namely, the aforesaid adhesion ratio specifies the adhesion state of minute inorganic particles and also specifies the buried state of the minute inorganic particles into the resinous particles which are employed as a nucleus. The aforesaid adhesion ratio is practically calculated based on the formula described below.

Adhesion ratio=1−Sh/{(1−x)Sa+xSb}

wherein Sa represents the specific surface area of minute resinous particles, Sb represents the specific surface area of minute inorganic particles, Sh represents the specific surface area of minute composite particles after adhering the minute inorganic particles onto the surface of the minute resinous particles, and x represents the addition ratio of the minute inorganic particles to the minute resinous particles.

The aforesaid adhesion ratio is preferably 25-100 percent, and is more preferably 40-80 percent. When the adhesion ratio is less than 25 percent, the degree of adhesion of the minute inorganic particles onto the minute resinous particles decreases, resulting in release of the minute inorganic particles from the surface. Due to this, when repeatedly used for an extended period of time, problems occur in which a photoreceptor is subjected to abrasion due to the release of minute inorganic particles. It is possible to control the adhesion ratio by changing the conditions of a production apparatus which achieves adhesion.

The ratio of the minute inorganic particles which constitute the minute composite particles to the minute resinous particles which are used as a nucleus-varies depending on the diameter of each particle. The minute inorganic particles which uniformly cover the minute resinous particles, which are employed as a nucleus, may be added. The ratio of the minute inorganic particles to the minute resinous particles is preferably 5-30 percent by weight.

<Colored Particles>

It is particularly preferable that colored particles are produced employing a polymerization method and further a production method in which resinous particles and colorant particles are salted out/fused in an aqueous medium.

The water based medium means one in which from 50 percent or more by weight of water, is incorporated. Herein, components other than water may include water-soluble organic solvents. Listed as examples are methanol, ethanol, isopropanol, butanol, acetone, methyl ethyl ketone, tetrahydrofuran, and the like.

<Monomers>

Radical polymerizable monomer is an essential component, and in addition thereto, a crosslinking agent may be employed. Further it is preferable to employ at least one of a radical polymerizable monomer having an acid group or a base group.

(1) Radically Polymerizable Monomers

One or more radical polymerizable monomers are employed to satisfy a required characteristics.

Practically, employed may be aromatic vinyl monomers, acrylic acid ester based monomers, methacrylic acid ester based monomers, vinyl ester based monomers, vinyl ether based monomers, monoolefin based monomers, diolefin based monomers, halogenated olefin monomers, and the like.

Listed as aromatic vinyl monomers, for example, are styrene based monomers and derivatives thereof such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrne, p-n-nonylstyrene, p-n-decylstyrene, p-n-dodecylstyrene, 2,4-dimethylstyrne, 3,4-dichlorostyrene, and the like.

Listed as (meth)acrylic acid and its ester bases monomers are methyl acrylate, ethyl acrylate, butyl acrylate, 2-ethylhexyl acrylate, cyclohexyl acrylate, phenyl-acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethyl aminoethyl methacrylate, diethyl aminoethyl methacrylate, and the like.

Listed as vinyl ester based monomers are vinyl acetate, vinyl propionate, vinyl benzoate, and the like.

Listed as vinyl ether based monomers are vinyl methyl ether, vinyl ethyl ether, vinyl isobutyl ether, vinyl phenyl ether, and the like.

Listed as monoolefin based monomers are ethylene, propylene, isobutylene, 1-butene, 1-pentene, 4-methyl-1-pentene, and the like.

Listed as diolefin based monomers are butadiene, isoprene, chloroprene, and the like.

Listed as halogenated olefin based monomers are vinyl chloride, vinylidene chloride, vinyl bromide, and the like.

(2) Crosslinking Agents

In order to improve the desired properties of toner, added as crosslinking agents may be radical polymerizable crosslinking monomers. Listed as radical polymerizable agents are those having at least two unsaturated bonds such as divinylbenzene, divinylnaphthalene, divinyl ether, diethylene glycol methacrylate, ethylene glycol dimethacrylate, polyethylene glycol dimethacrylate, phthalic acid diallyl, and the like.

(3) Radical Polymerizable Monomer Having Acid Group or Base Group

Examples of the radical polymerizable monomer having acid group or base group are carboxyl group containing monomer, sulfonic acid containing monomer, and amine compound such as primary amine, secondary amine, tertiary amine, and quaternary amine.

Examples of the carboxyl group containing monomer are acrylic acid, methacrylic acid, fumaric acid, maleic acid, itaconic acid, cinnamic acid, maleic monobutylate, and maleic monooctylate.

Examples of the sulfonic acid group containing monomer are styrenesulfonic acid, allylsulfosuccinic acid, and octyl allylsulfosuccinate.

These may be in the form of alkali metal salt such as sodium and potassium, or alkali earth metal salt such as calcium.

Examples of the radical polymerization monomer containing base is listed as amine compounds, specifically, dimethylaminoethylacrylate, dimethylaminoethylmethacrylate, diethylaminoethylacrylate, diethylaminoethylmethacrylate, and quaternary ammonium slat of the above four compounds, 3-dimethylaminophenylacrylate, 2-hydroxy-3-methacryloxy propyl trimethylammonium salt, acrylamide, N-butylacrylamide, N,N-dibutyl acrylamide, piperidyl acrylamide, methacrylamide, N-butylmethacrylamide, N-octadecyl acrylamide; vinyl N-methylpyridinium chloride, vinyl N-ethyl pyridinium chloride, N,N-diallyl methylammonium chloride and N,N-diallyl ethylammonium chloride.

As for the amount of the radical polymerization monomer, radical polymerizable monomer containing acid group or base group is 0.1 to 15 weight % with reference to the total amount of the monomers. The amount of the radical polymerization crosslinking agent, which varies depending on its property, is 0.1 to 10 weight % with reference to the whole radical polymerizable monomers.

Chain Transfer Agents

Aiming at the adjustment of molecular weight, generally used chain transfer agents may be employed.

Examples of the chain transfer agents include mercaptans such as octylmercaptan, dodecylmercaptan, tert-dodecylmercaptan, n-octyl-3-mercapto propionic acid ester, carbon tetrabromide, a-methylstyrene dimer, etc.

Polymerization Initiators

Water-soluble radical polymerization initiators may be optionally employed in the present invention. For example, are listed persulfate salts (potassium persulfate, ammonium persulfate, etc.), azo series compounds (4,4′-azobis-4-cyano valeric acid and its salt, 2,2′-azobis(2-amodinopropane) salt, etc. peroxide compounds.

Furthermore, the above-mentioned radical polymerization initiator may be employed in combination with a reducing agent if desired, and may be employed as a redox system initiator. The use of the redox system initiator enables the increase in polymerization activity and the decrease in polymerization temperature. As a result, the reduction in polymerization time may be expected.

The polymerization temperature is not limited if the temperature is higher than the lowest temperature at which the polymerization initiator induces the formation of a radical. The temperature of 50 to 90° C. is employed. However, the use of the polymerization initiator such as, for example, a combination of hydrogen peroxide-reducing agent (ascorbic acid, etc.) which enables initiation at room temperature makes it possible to conduct the polymerization at room temperature or lower.

Surface Active Agents

Surface active agent is employed in polymerization using the radical polymerizable monomer to disperse in a water based medium. The following ionic surface active agents are preferably employed.

The ionic surface active agents include sulfonic acid salts such as sodium dodecylbenzenesulfonate, sodium arylalkylpolyethersulfonate, sodium 3,3-disulfondiphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate, etc., sulfonic ester salts such as sodium tetradecylsulfate, sodium pentadecylsulfate, sodium octylsulfate, etc., fatty acid salts such as sodium oleate, sodium laurate, sodium caprate, sodium caprylate, sodium caproate, potassium stearate, calcium oleate, etc.

A nonion surfactant may be employed in the invention. Practically, examples thereof include polyethylene oxide, polypropylene oxide, combination of polyethylene oxide and polypropylene oxide, ester of polyethylene glycol and higher aliphatic acid, alkylphenol polyethylene oxide, ester of higher aliphatic acid and polyethylene glycol, ester of higher aliphatic acid and polypropylene oxide, and sorbitan ester.

These surfactants are employed as an dispersing agent during emulsion polymerization, and they may be employed for other purpose during other procedure.

Colorants

Colorants include inorganic colorants, organic colorants and dyes.

Examples of inorganic colorants are described.

Carbon black such as furnace black, channel black, acetylene black, thermal black and lamp black is exemplified as black pigment. Magnetic powders such as magnetite and ferrite are employed for black pigment.

These inorganic pigments can be used individually or two or more in combination selected according to needs. And the content of pigment is usually 2-20 mass %, and preferably, 3-15 mass % of polymer.

The above-mentioned magnetite can be employed to use as magnetic toner. It is preferable to employ 20-60 mass % of magnetite in toner from a point of view to give predetermined magnetic characteristics in this case.

An organic pigment can be also employed. Practical organic pigment is exemplified below.

Magenta or Red Pigment

C.I. Pigment red 2, C.I. Pigment red 3, C.I. Pigment red 5, C.I. Pigment red 6, C.I. Pigment red 7, C.I. Pigment red 15, C.I. Pigment red 16, C.I. Pigment red 48:1, C.I. Pigment red 53:1, C.I. Pigment red 57:1, C.I. Pigment red 122, C.I. Pigment red 123, C.I. Pigment red 139, C.I. Pigment red 144, C.I. Pigment red 149, C.I. Pigment red 166, C.I. Pigment red 177, C.I. Pigment red 178, and C.I. pigment red 222.

Orange or Yellow Pigment

C.I. Pigment orange 31, C.I. Pigment orange 43, C.I. Pigment yellow 12, C.I. Pigment yellow 13, C.I. Pigment yellow 14, C.I. Pigment yellow 15, C.I. Pigment yellow 17, C.I. Pigment yellow 93, C.I. Pigment yellow 94, C.I and Pigment yellow 138.

Green or Cyan Pigment

C.I. Pigment blue 15, C.I. Pigment blue 15:2, C.I. Pigment blue 15:3, C.I. Pigment blue 16, C.I. Pigment blue 60 and C.I. pigment green 7.

Dyes

C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Red 58, C.I. Solvent Yellow 19, C.I. Solvent Yellow 44, C.I. Solvent Yellow 77, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent blue 25, C.I. Solvent blue 36, C.I. Solvent blue 60, C.I. Solvent blue 70, C.I. Solvent blue 93, C.I. Solvent blue 25, and C.I. Solvent blue 95. The mixture of these may also be employed.

These organic pigments can be used individually or two or more jointly selected according to needs. And content of pigment is usually 2-20 mass % and preferably 3-15 mass % for polymer.

The colorant subjected to surface modification can be employed. The practical surface modifying agent includes silane coupling agent, titanium coupling agent and aluminum coupling agent.

Other Components

The following components may be employed in the colored particles.

The toner particles may optionally contain a compound having releasing function. Preferable examples of the releasing agent having releasing property include low molecular weight polyolefin wax such as polypropylene and polyethylene, paraffin wax, Fischer-Tropsch wax, and ester wax. A particularly preferable example is an ester compounds represented by a formula described below.

R₁—(OCO—R₂)ₙ

In the formula, n represents an integer of 1 to 4, and preferably 2 to 4, more preferably 3 or 4, and in particular preferably 4.

R₁ and R₂ each represent a hydrocarbon group which may have a substituent respectively. R₁ has from 1 to 40 carbon atoms, and preferably 1 to 20, more preferably 2 to 5. R₂ has from 1 to 40 carbon atoms, and preferably 16 to 30, more preferably 18 to 26.

Practical compounds are exemplified.

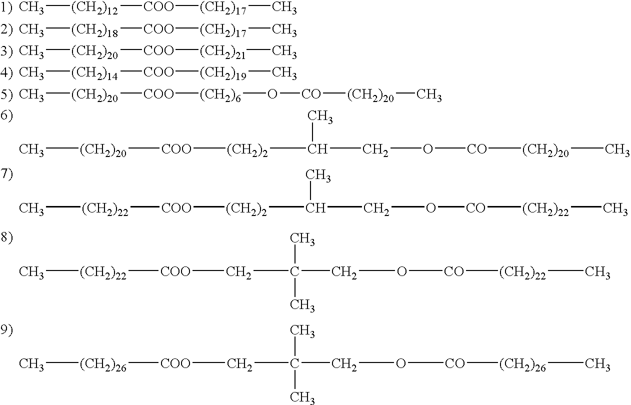

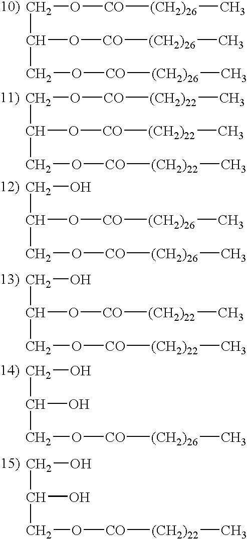

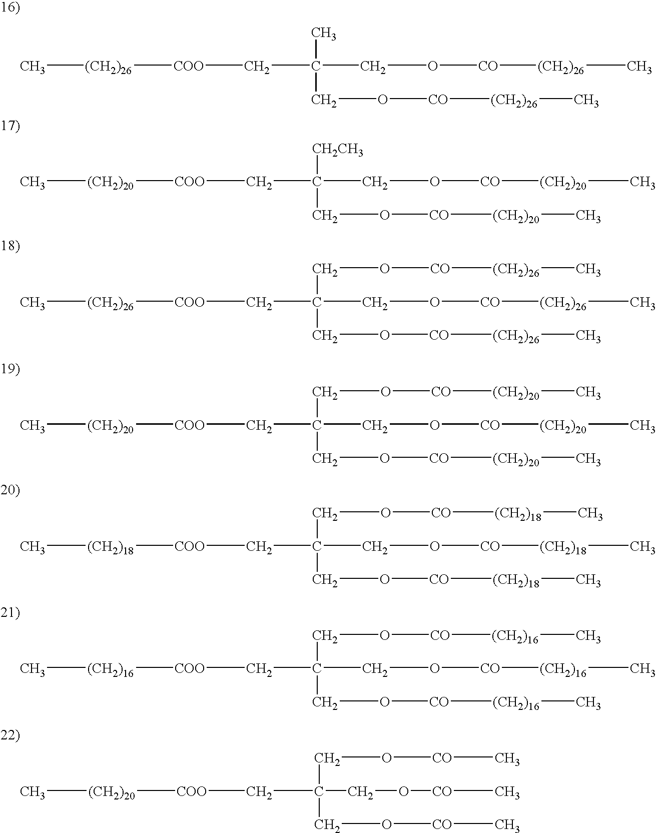

As a containing ratio of the compound in the toner, it is preferable that crystalline polyester is from 1 to 30 percent by weight, and more preferably from 2 to 20 percent by weight, and in particular from 3 to 15 percent by weight of toner weight as a whole.

One example to incorporate the releasing agent in a toner particle is salting out/fusing a resin particles and the releasing agent particle in a water based medium. The other preferable example is a way in which the releasing agent is dispersed, after it is dissolved in monomer, in water and the monomer is polymerized to form particles containing the releasing agent, then the particles are subjected to salting out/fusing together with colorant particles to form colored particles.

Methods are preferred in which dispersion is carried out employing mechanical force. Said monomer solution is preferably subjected to oil droplet dispersion (essentially an embodiment in a mini-emulsion method), employing mechanical force, especially into water based medium prepared by dissolving a surface active agent at a concentration of lower than its critical micelle concentration. An oil soluble polymerization initiator may be added to the monomer solution.

Herein, homogenizers to conduct oil droplet dispersion, employing mechanical forces, are not particularly limited, and include, for example, “CLEARMIX”, ultrasonic homogenizers, mechanical homogenizers, and Manton-Gaulin homogenizers and pressure type homogenizers.

The colorants may also be employed while subjected to surface modification. Surface of the colorant may be modified in such way that the surface modifier is added to the dispersion of colorant, then the dispersion is heated to conduct reaction. Colorant having subjected to the surface modification is separated by filtration and dried after repeating rinsing and filtering with the same solvent.

Colorant particles can be prepared by dispersing the colorant in a water based medium. The dispersion process is undergone in the presence of a surface active agent at a concentration higher than or equal to the critical micelle concentration (CMC).

Listed as dispersion devices employed for the dispersion process of said coloring agent particles may be, in addition to CLEARMIX, pressure homogenizers such as ultrasonic homogenizers, mechanical homogenizers, Manton-Gaulin homogenizer, and pressure type homogenizers, and medium type homogenizers such as Getzman dispersers and fine diamond mills.

The preferred salting-out/fusing method comprises a process in which a salting-out agent, comprised of alkali metal salts, alkali earth metal salts, and the like, is added as a flocculent into water comprising fine resin particles as well as fine colorant particles in an amount of exceeding the critical flocculation concentration and subsequently, by heating at a temperature above the glass transition point of said fine resin particles, salting-out and fusion are simultaneously carried out.

Herein, in alkali metal salts and alkali earth metal salts employed as salting-out agents, listed as alkali metals are lithium, potassium, sodium, and the like, and as alkali earth metal are magnesium, calcium, strontium, barium, and the like. Cited as preferred metals are potassium, sodium, magnesium, calcium, and barium. Cited as formed salts are chlorides, bromides, iodides, carbonates, sulfates, and the like.

Toner Preparation by Polymerization Method

Mono-valent metal salt and water is preferably added to terminate salting out/fusing process, and further restrain producing larger or smaller particle than required particle size.

Additives in Toner Particles

The toner may contain a component giving various function to a toner other than a releasing agent and colorant. Practical example is a charge control agent. The component may be incorporated in toner particle by such a way that the component is added as well as resin particles and colorant particle simultaneously during the salting out/fusing process, or the component is added directly to resin particles.

Various charge control agents capable of being dispersed in water may be empolyed. Specifically listed are nigrosine based dyes, metal salts of naphthenic acid or higher fatty acids, alkoxylated amines, quaternary ammonium salts, azo based metal complexes, salicylic acid metal salts or metal complexes thereof, and the like.

Amount of external additive is preferably 0.1 to 5 weight % based on toner. These are added by means of various kinds of mixing apparatus such as a turbular mixer, a Henscel mixer, a nouter mixer, and a V-type mixing machine.

(Developer):

Listed as single-component developers are a non-magnetic single-component developer, and a magnetic single-component developer.

The toner is blended with a carrier and employed as a two-component developer. In this instance, employed as magnetic particles of the carrier may be conventional materials known in the art, such as metals such as iron, ferrite, magnetite, and the like, alloys of said metals with aluminum, lead and the like. Specifically, ferrite particles are preferred. The volume average particle diameter of said magnetic particles is preferably from 15 to 100 μm. and is more preferably from 25 to 80 μm.

The volume average particle size of a carrier can be measured representatively by a laser-diffraction-type particle diameter distribution measuring apparatus equipped with a wet-type dispersion machine “HELOS” (manufactured by SYMPATEC Corp.).

Preferred carrier is one in which magnetic particles are further coated with resins or a so-called resin dispersion type carrier in which magnetic particles are dispersed into resins. Resin compositions for coating are not particularly limited. For example, employed are olefin based resins, styrene based resins, styrene-acryl based resins, silicone based resins, ester based resins, or fluorine containing polymer based resins. Further, resins, which constitute said resin dispersion type carrier, are not particularly limited, and resins known in the art may be employed. For example, listed may be styrene-acryl based resins polyester resins, fluorine based resins, phenol resins, and the like.

The volume average diameter of the carrier can be measured representatively by laser diffraction particle size distribution measuring apparatus “HELOS” (made by SYMPATEC Co.).

As the carrier, the coated carrier in which magnetic particles are coated with resin or the resin dispersed type carrier in which magnetic particles are dispersed in resin is preferable. The coating resin is not specially restricted, but for example, olefin resin, styrene resin, styrene-acryl resin, silicone resin, ester resin or fluorine containing polymer can be used. As the resin constituting resin dispersed type carrier, especially not restricted but publicly known resin such as styrene-acryl resin, polyester resin, fluorine resin or phenol resin can be used.

As the photoreceptor used for the image forming apparatus of the present invention, concretely cited are, an inorganic photoconductor such as a selenium photoconductor and an arsenic selenium photoconductor, an amorphous silicone photoconductor and an organic photoconductor, however from the viewpoints of cost and environmental issue, an organic photoconductor is especially useful. An organic photoconductor is typically structured by dispersing organic photoconductive material in a resin, wherein organic compound has a function of charge generation and/or charge transportation.

Preferable example includes a drum-shaped or belt-shaped photoreceptor.

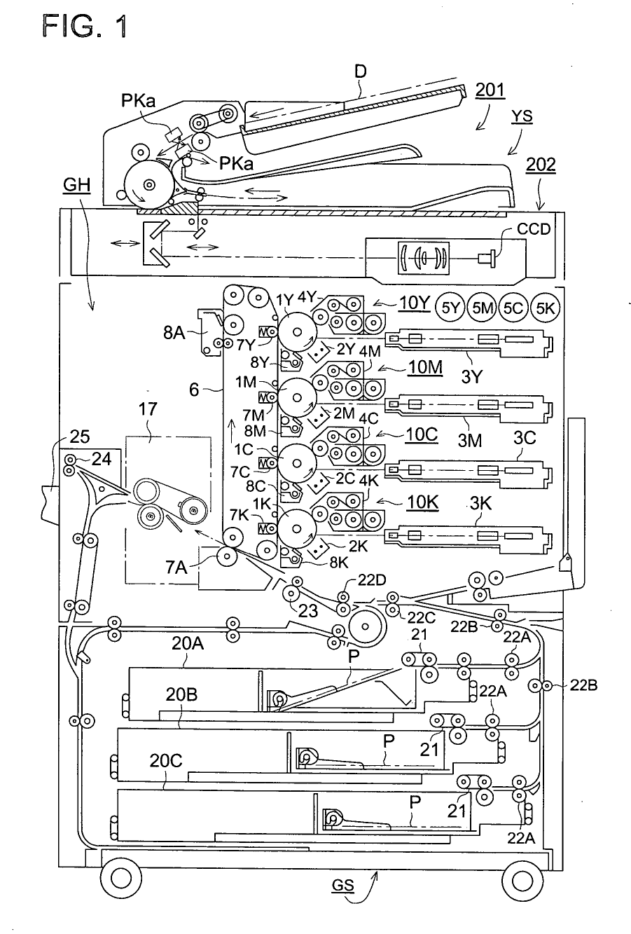

In FIG. 1, the color image forming apparatus 201 is made up of an image forming apparatus mainframe GH and an image reading apparatus YS.

On the image forming apparatus mainframe, the image reading apparatus made up of an automatic document feeder 201 and a document image scanning exposure device 202 is mounted. A document sheet d placed on the document table of the automatic document feeder 201 is conveyed by a conveyance means, and by means of the optical system of the document image scanning exposure device 202, an image on one or both sides of the document is subjected to scanning exposure, and is read by a line image sensor CCD.

Glossiness of document image, determination of monochrome or color image, and single side or double side image are checked by a glossiness level detector sensor Pka as a glossiness level selecting means.

The analog signals obtained by the reading of the line image sensor CCD are subjected to an analog processing, A/D conversion, a shading correction processing, an image compression processing, etc. in an image processing section (not shown in the drawing), to become image information. After that, the image information is transmitted to image writing sections (exposure means) 3Y, 3M, 3C, and 3K, which make up the respective image forming units.

The automatic document feeder 201 is equipped with an automatic double-sided document conveyance means. This automatic document feeder 201 reads the content of a multi-page document d fed from on the document table by a single continuous run, and the content of the document is accumulated in a storage means (an electronic RDH function). This electronic RDH function is conveniently used when the content of a multi-page document is copied by the copying function, or when a multi-page document d is transmitted by the facsimile function, for example.

The image forming apparatus mainframe GH is what is called a tandem-type color image forming apparatus, and is composed of a plurality of image forming units (image forming system) 10Y, 10M, 10C, and 10K, an endless intermediate transfer belt 6 as an intermediate transfer member which is an example of the image transfer means (the image transfer system), a paper feed-conveyance means containing a re-feed mechanism (an ADU mechanism), and a fixing device 17 for fixing a toner image.

The image forming unit 10Y for forming an image of the color yellow (Y) comprises a photoreceptor drum 1Y as an image forming member, and a charging means 2Y, an exposure means 3Y, a developing device 4Y and a cleaning means 8Y for the image forming member for the color Y arranged at the circumference of the photoreceptor drum 1Y. The image forming unit 10M for forming an image of the color magenta (M) comprises a photoreceptor drum 1M as an image forming member, and a charging means 2M, an exposure means 3M, a developing device 4M, and a cleaning means 8M for the image forming member for the color M.

The image forming unit 10C for forming an image of the. color cyan (C) comprises a photoreceptor drum 1C as an image forming member, and a charging means 2C, an exposure means 3C, a developing device 4C, and a cleaning means 8C for the image forming member for the color C. The image forming unit 10K for forming an image of the color black (BK) comprises a photoreceptor drum 1K as an image forming member, and a charging means 2K, an exposure means 3K, a developing device 4K, and a cleaning means 8K for the image forming member for the color BK.

The combinations of the charging means 2Y and the exposure means 3Y, the charging means 2M and the exposure means 3M, the charging means 2C and the exposure means 3C, and the charging means 2K and the exposure means 3K make up latent image forming means respectively. As regards the development by means of the developing devices 4Y, 4M, 4C, or 4K, it is practiced a reverse development process with a developing bias voltage composed of a direct-current voltage having the polarity the same as that of the toners used (negative polarity in this example of the embodiment) and an alternate-current voltage superposed applied.

The intermediate transfer belt 6 is entrained about a plurality of rollers and is supported in a way to be able to revolve.

The outline of an image forming process will be explained in the following.

Images of the respective colors formed by the image forming units 10Y, 10M, 10C, and 10K are transferred successively onto the revolving intermediate transfer belt 6 by the primary transfer rollers 7Y, 7M, 7C, and 7K having a primary transfer bias voltage (not shown in the drawing) of the polarity reverse to the toners used (positive polarity in this example of the embodiment) applied respectively (primary transfer), and a synthesized color image (color toner image) is formed. The color image is transferred from the intermediate transfer belt 6 to a paper sheet P.

A paper sheet P contained in a paper feed cassette 20A, 20B, or 20C is fed by a conveying-out roller 21 and feed roller 22A which are provided in each of the paper feed cassette 20A, 20B, and 20C, and is conveyed through conveyance rollers 22B, 22C, and 22D, a registration roller 23, etc. to a secondary transfer roller 7A; thus, on one side (front side) of the paper sheet P, the color image is transferred (secondary transfer).

The paper sheet P, having a color image transferred on it, is subjected to the fixing process by the fixing device 17, and is gripped by a pair of ejection rollers 17, to be placed on an output tray 25 outside the machine.

The residual toner particles remaining on the circumferential surface of the photoreceptor drums 1Y, 1M, 1C, and 1K are removed by the image forming member cleaning means 8Y, 8M, 8C, and 8K, and the next image formation cycle will start.

Residual toner is removed from the intermediate transfer belt 6 which has separated recording paper P by a intermediate transfer belt cleaner 8A, after transferring color image to the recording paper P by a secondary transfer roller 7A.

Though the invention is detailed through a example of color image forming method, it is also applicable to a monochrome image forming method.

### EXAMPLES

The embodiments and effects of the present invention will specifically be described with reference to examples. In these description, “parts” refers to “parts by weight”.

### Latex Preparation Example 1

Charged into a 5,000 ml separable flask fitted with a stirring unit, a thermal sensor, a cooling pipe, and a nitrogen inlet device was a solution prepared by dissolving 7.08 g of an anionic surfactant (being sodium dodecylbenzenesulfonate: SDS) in ion-exchange water (2,760 g). While stirring at 230 rpm, the interior temperature was raised to 80° C. under a stream of nitrogen. On the other hand, 72.0 g of Exemplified Compound 19) was added to monomers comprised of 115.1 g of styrene, 42.0 g of n-butyl acrylate, and 10.9 g of methacrylic acid and dissolved at 80° C., whereby a monomer solution was prepared. Subsequently, the aforesaid heated solutions were mixed and dispersed employing a mechanical type homogenizer having a circulation channel, whereby emulsified particles having a uniform diameter of dispersed particles were prepared. Subsequently, a solution prepared by dissolving 0.84 g of a polymerization initiator (potassium persulfate: KPS) in 200 g of ion-exchange water was added. While stirring, the resulting mixture was heated at 80° C. for 3 hours, whereby latex particles were prepared. A solution prepared by dissolving 7.73 g of the polymerization initiator (KPS) in 240 ml of ion-exchange water was added. After 15 minutes, a composition mixture consisting of 383.6 g of styrene, 140.0 g of n-butyl acrylate, 36.4 g of methacrylic acid, and 14.0 g of n-octylmercaptan was dripped at 80° C. over 120 minutes. After dripping, the resulting mixture was heated while stirring for an additional 60 minutes and then cooled to 40° C., whereby latex particles were prepared.

The resulting latex particles were designated as Latex 1.

### Toner Preparation Example

Production of Colored Particles 1Bk

While stirring, 9.2 g of sodium dodecylsulfate was dissolved in 160 ml of ion-exchange water. While stirring, 20 g of Regal 330R (carbon black, manufactured by Cabot Corp.) was gradually added to the resulting solution. Subsequently, the resulting mixture was dispersed employing Clearmix. The particle diameter of the aforesaid dispersion was determined employing an electrophoretic light scattering spectrophotometer ELS-800, manufactured by Otsuka Electronics Co., Ltd., resulting in a weight average diameter of 112 nm. The resulting dispersion was designated as “Colorant Dispersion 1”.

Charged into a 5-liter four-necked flask fitted with a thermal sensor, a cooling pipe, a nitrogen gas inlet device, and a stirring device, were 1,250 g of “Latex 1”, 2,000 ml of ion-exchange water, and “Colorant Dispersion 1”, and the resulting mixture was stirred. After adjusting the temperature to 30° C., the pH of the mixture was adjusted to 10.0 by adding a 5 mol/liter aqueous sodium hydroxide solution. Subsequently, while stirring, an aqueous solution prepared by dissolving 110 g of magnesium chloride hexahydrate in 72 ml of ion-exchange water was added at 30° C. over 5 minutes. Thereafter, the resulting mixture was left standing for 30 seconds and then heated to 90° C. over 5 minutes (at a temperature increase rate of 12° C./minute) While under such a state, the particle diameter was determined employing a Coulter Counter TA-II. When the volume average particle diameter reached 5.3 μm, growth of particles was terminated by adding an aqueous solution prepared by dissolving 115 g of sodium chloride in 700 ml of ion-exchange water. The resulting composition was continuously stirred at 90±2° C. for 8 hours and was subjected to salting-out/fusion. Thereafter, the resulting composition was cooled to 30° C. at a rate of 6° C./minute. Subsequently, the pH was adjusted to 2.0 by adding hydrochloric acid and stirring was terminated. Formed colored particles were filtered/washed under the conditions described below and thereafter, were dried by 40° C. air flow, whereby colored particles were prepared. The resulting colored particles were designated as “Colored Particles 1Bk”.

Colored Particles 1Y

Colored particles were prepared in the same manner as Colored Particles 1Bk, except that the carbon black was replaced with C.I. Pigment Yellow 185. The resulting particles were designated as “Colored Particles 1Y”.

Colored Particles 1M

Colored particles were prepared in the same manner as Colored Particles 1Bk, except that the carbon black was replaced with C.I. Pigment Red 122. The resulting particles were designated as “Colored Particles 1M”.

Colored Particles 1C

Colored particles were prepared in the same manner as Colored Particles 1Bk, except that the carbon black was replaced with C.I. Pigment Blue 15:3. The resulting particles were designated as “Colored Particles 1C”.

Further, colored particles were prepared by changing the conditions to the ones described below.

TABLE 1

| | | | Salting-Out/Fusion | |
|---|---|---|---|---|
| | Added Amount | Temperature | | Main- |
| Colored | of Salting- | Increase | Liquid | tained |
| Particles No. | Out Agent | Rate | Temperature | Time |
| Colored | MgCl₂: 110 g | 12° C./minute | 90 ± 2° C. | 8 hours |
| Particles 1Bk | | | | |
| Colored | MgCl₂: 110 g | 12° C./minute | 90 ± 2° C. | 8 hours |
| Particles 1Y | | | | |
| Colored | MgCl₂: 110 g | 12° C./minute | 90 ± 2° C. | 8 hours |
| Particles 1M | | | | |
| Colored | MgCl₂: 110 g | 12° C./minute | 90 ± 2° C. | 8 hours |
| Particles 1C | | | | |
| Colored | AlCl₃: 56 g | 15° C./minute | 90 ± 2° C. | 6 hours |
| Particles 2Bk | | | | |
| Colored | AlCl₃: 56 g | 15° C./minute | 90 ± 2° C. | 6 hours |
| Particles 2Y | | | | |
| Colored | AlCl₃: 56 g | 15° C./minute | 90 ± 2° C. | 6 hours |
| Particles 2M | | | | |
| Colored | AlCl₃: 56 g | 15° C./minute | 90 ± 2° C. | 6 hours |
| Particles 2C | | | | |
| Colored | AlCl₃: 56 g | 5° C./minute | 90 ± 2° C. | 6 hours |
| Particles 3Bk | | | | |
| Colored | AlCl₃: 56 g | 5° C./minute | 90 ± 2° C. | 6 hours |
| Particles 3Y | | | | |
| Colored | AlCl₃: 56 g | 5° C./minute | 90 ± 2° C. | 6 hours |
| Particles 3M | | | | |
| Colored | AlCl₃: 56 g | 5° C./minute | 90 ± 2° C. | 6 hours |
| Particles 3C | | | | |
| Colored | Al(OH)₃: 70 g | 12° C./minute | 90 ± 2° C. | 8 hours |
| Particles 4Bk | | | | |
| Colored | Al(OH)₃: 70 g | 12° C./minute | 90 ± 2° C. | 8 hours |
| Particles 4Y | | | | |
| Colored | Al(OH)₃: 70 g | 12° C./minute | 90 ± 2° C. | 8 hours |
| Particles 4M | | | | |
| Colored | Al(OH)₃: 70 g | 12° C./minute | 90 ± 2° C. | 8 hours |
| Particles 4C | | | | |

TABLE 2

| | Volume Average |
|---|---|
| Colored Particles No. | Particle Diameter |
| Colored Particles 1Bk | 5.4 μm |
| Colored Particles 1Y | 5.4 μm |
| Colored Particles 1M | 5.4 μm |
| Colored Particles 1C | 5.4 μm |
| Colored Particles 2Bk | 5.4 μm |
| Colored Particles 2Y | 5.4 μm |
| Colored Particles 2M | 5.4 μm |
| Colored Particles 2C | 5.4 μm |
| Colored Particles 3Bk | 5.4 μm |
| Colored Particles 3Y | 5.4 μm |
| Colored Particles 3M | 5.4 μm |
| Colored Particles 3C | 5.4 μm |
| Colored Particles 4Bk | 4.2 μm |
| Colored Particles 4Y | 4.2 μm |
| Colored Particles 4M | 4.2 μm |
| Colored Particles 4C | 4.2 μm |

### Comparative Toner Production Example

Comparative Colored Particles 1Bk

Under a dry system, 100 parts of styrene acryl resin, 10 parts of Exemplified Compound 19), and 10 parts of carbon black were mixed, fuse-kneaded and pulverized, whereby colored particles of a volume average particle diameter of 5.5 μm were prepared. The content of particles of at most 2.5 μm was 11 percent by volume. The resulting particles were designated as Comparative Colored Particles 1Bk.

Comparative Colored Particles 1Y

Colored particles were prepared in the same manner as Comparative Colored Particles 1Bk, except that the carbon black was replaced with C.I. Pigment Yellow 185. The volume average particle diameter of the resulting particles was 5.6 μm, and the content of particles of at most 2.5 μm was 10 percent by volume. The resulting parties were designated as Comparative Colored Particles 1Y.

Comparative Colored Particles 1M

Colored particles were prepared in the same manner as Comparative Colored Particles 1Bk, except that the carbon black was replaced with C.I. Pigment Red 122. The volume average particle diameter of the resulting particles was 5.6 μm, and the content of particles of at most 2.5 μm was 10 percent by volume. The resulting particles were designated as Comparative Colored Particles 1M.

Comparative Colored Particles 1C

Colored particles were prepared in the same manner as Comparative Colored Particles 1Bk, except that the carbon black was replaced with C.I. Pigment Blue 15:3. The volume average particle diameter of the resulting particles was 5.5 μm, and the content of particles of at most 2.5 μm was 10 percent by volume. The resulting particles were designated as Comparative Colored Particles 1C.

Subsequently, external additives described below were added to each of aforesaid “Colored Particles 1Bk” through “Comparative Colored Particles 1C”.

TABLE 3

| | Colored Particles | Composition of External |
|---|---|---|
| Toner No. | No. | Additives (volume %) |
| Toner 1BK | Colored Particles | Silica 1:0.6 |
| | 1Bk | Titania 1:0.7 |
| Toner 1Y | Colored Particles | Silica 1:0.6 |
| | 1Y | Titania 1:0.7 |
| Toner 1M | Colored Particles | Silica 1:0.6 |
| | 1M | Titania 1:0.7 |
| Toner 1C | Colored Particles | Silica 1:0.6 |
| | 1C | Titania 1:0.7 |
| Toner 2BK | Colored Particles | Silica 1:0.5 |
| | 2BK | Titania 1:0.5 |
| | | Minute organic particles 1:1.0 |
| Toner 2Y | Colored Particles | Silica 1:0.5 |
| | 2Y | Titania 1:0.5 |
| | | Minute organic particles 1:1.0 |
| Toner 2M | Colored Particles | Silica 1:0.5 |
| | 2M | Titania 1:0.5 |
| | | Minute organic particles 1:1.0 |
| Toner 2C | Colored Particles | Silica 1:0.5 |
| | 2C | Titania 1:0.5 |
| | | Minute organic particles 1:1.0 |
| Toner 3BK | Colored Particles | Silica 1:0.4 |
| | 3Bk | Titania 1:0.4 |
| Toner 3Y | Colored Particles | Silica 1:0.4 |
| | 3Y | Titania 1:0.4 |
| Toner 3M | Colored Particles | Silica 1:0.4 |
| | 3M | Titania 1:0.4 |
| Toner 3C | Colored Particles | Silica 1:0.4 |
| | 3C | Titania 1:0.4 |
| Toner 4BK | Colored Particles | Silica 1:0.8 |
| | 4Bk | Titania 1:0.4 |
| | | Silica 2:1.0 |
| Toner 4Y | Colored Particles | Silica 1:0.8 |
| | 4Y | Titania 1:0.4 |
| | | Silica 2:1.0 |
| Toner 4M | Colored Paticles | Silica 1:0.8 |
| | 4M | Titania 1:0.4 |
| | | Silica 2:1.0 |
| Toner 4C | Colored Particles | Silica 1:0.8 |
| | 4C | Titania 1:0.4 |
| | | Silica 2:1.0 |
| Comparative | Comparative Colored | Silica 1:0.6 |
| Toner 1Bk | Particles 1Bk | Titania 1:0.7 |
| Comparative | Comparative Colored | Silica 1:0.6 |
| Toner 1Y | Particles 1Y | Titania 1:0.7 |
| Comparative | Comparative Colored | Silica 1:0.6 |
| Toner 1M | Particles 1M | Titania 1:0.7 |
| Comparative | Comparative Colored | Silica 1:0.6 |
| Toner 1C | Particles 1C | Titania 1:0.7 |

Silica 1: hydrophobic silica treated with hexamethyldisilazane (number average diameter of the primary particles = 10 nm and hydrophobic degree = 68)
Titania 1: hydrophobic titanium oxide treated with octyltrimethoxysilane (number average diameter of the primary particles = 40 nm and hydrophobic degree = 63)
Silica 2: hydrophobic silica treated with hexamethyldisilazane (number average diameter of the primary particles = 210 nm and hydrophobic degree = 71)
Minute organic particles 1: PMMA particles of a number average diameter of the primary particles of 800 nm, prepared employing a soap free polymerization method

Incidentally, external additives were mixed employing a Henschel mixer whereby toners were prepared. These toners were designated as “Toner 1Bk” through “Comparative Toner 1C”.

Mixing conditions were as follows. Silica 1 and/or Titania 1 was added to colored particles in the specified amount, and the resulting mixture was stirred at a peripheral rate of 50 m/second for 3 minutes, employing a Henschel mixer. Subsequently, if desired, other additives were added. The resulting mixture was stirred for 20 minutes while decreasing the peripheral rate to 35 m/second. In each case, a method was used in which the jacket of the Henschel mixer was cooled employing 5° C. chilled water and external additives were not excessively buried.

Employing each of the toners prepared as above, the existing state of particles of at most 2.5 μm was evaluated.

The amount of the external additives, which was to be used in practice, was determined in such a manner that 10 g of each toner was sieved employing a 400-mesh sieve and the difference in the amount of external additives between prior to and after the sieving process was converted to volume by percent.

TABLE 4

| | Volume % of Particles of | | |
|---|---|---|---|
| | 2.5 μm or Less | | |
| | | Colored | External |
| Toner | Total | Particles | Additives |
| Toner 1Bk | 4.6% | 4.3% | 0.3% |
| Toner 1Y | 4.6% | 4.3% | 0.3% |
| Toner 1M | 4.6% | 4.3% | 0.3% |
| Toner 1C | 4.6% | 4.3% | 0.3% |
| Toner 2Bk | 4.7% | 3.6% | 1.1% |
| Toner 2Y | 4.7% | 3.6% | 1.1% |
| Toner 2M | 4.7% | 3.6% | 1.1% |
| Toner 2C | 4.7% | 3.6% | 1.1% |
| Toner 3Bk | 3.0% | 2.9% | 0.1% |
| Toner 3Y | 3.0% | 2.9% | 0.1% |
| Toner 3M | 3.1% | 3.0% | 0.1% |
| Toner 3C | 3.2% | 3.1% | 0.1% |
| Toner 4Bk | 7.2% | 6.8% | 0.4% |
| Toner 4Y | 7.2% | 6.8% | 0.4% |
| Toner 4M | 6.9% | 6.5% | 0.4% |
| Toner 4C | 7.2% | 6.8% | 0.4% |
| Comparative Toner 1Bk | 12.4% | 12.0% | 0.4% |
| Comparative Toner 1Y | 11.4% | 11.0% | 0.4% |
| Comparative Toner 1M | 11.4% | 11.0% | 0.4% |
| Comparative Toner 1C | 11.4% | 11.0% | 0.4% |

Each of the aforesaid toners was mixed with a silicone resin coated ferrite carrier of a volume average particle diameter of 60 μm, whereby developers at a toner concentration of 6 percent were prepared. These were designated as “Developer 1Bk” through “Comparative Developer 1C”, corresponding to each of the toners.

The image forming method shown in FIG. 1 was used. A tandem type color image forming apparatus utilizing an intermediate transfer body system was used. A blade cleaning system was employed as the cleaning mechanism and a counter type was also used.

At 30° C. and 80 percent relative humidity (HH ambience) a full color image at a pixel ratio of 25 percent was printed on 200,000 sheets. Employing the resulting images, the image quality was evaluated.

TABLE 5

| | Presence or Absence of |
|---|---|
| Developer No. | Image Problems |
| Developers 1Bk/1Y/1M/1C | formation of excellent |
| | images without filming |
| Developers 2Bk/2Y/2M/2C | formation of excellent |
| | images without filming |
| Developers 3Bk/3Y/3M/3C | formation of excellent |
| | images without filming |
| Developers 4Bk/4Y/4M/4C | formation of excellent |
| | images without filming |
| Comparative Developers | formation of filming |
| 1Bk/1Y/1M/1C | and black streaking |
| | problems |

As can clearly be seen from Table 5 above, all developers within the present invention resulted in no filming and excellent images, while comparative developers beyond the present invention resulted in problems.

According to the present invention, it is possible to provide an electrostatic latent image developing toner which is capable of forming high quality images at a high rate, results in no toner filming on an electrostatic latent image forming body (being a photoreceptor), as well as in excellent transferability, and is capable of forming images without unevenness, and an image forming method using the same.

1. An electrostatic latent image developing toner which comprises colored particles, comprising a resin and a colorant, and external additive particles,
wherein a volume average particle diameter of the toner is 4.0-8.0 μm and a sum of the colored particles and the external additive particles having particle diameter of at most 2.5 μm is 0.1-10 percent by volume based on the sum of the colored particles and the external additive particles.

2. The electrostatic latent image developing toner of claim 1 wherein the sum of the colored particles and the external additive particles having particle diameter of at most 2.5 μm is 0.3-8 percent by volume based on the sum of the colored particles and the external additive particles.

3. The electrostatic latent image developing toner of claim 1 wherein the external additive particles having particle diameter of at most 2.5 μm is 0.5-5 percent by volume based on the sum of the colored particles and the external additive particles.

4. The electrostatic latent image developing toner of claim 1 wherein colored particles having particle diameter of at most 2.5 μm is 9 percent or less by volume based on the colored particles.

5. The electrostatic latent image developing toner of claim 4 wherein colored particles having particle diameter of at most 2.5 μm is 0.05-8 percent by volume based on the colored particles.

6. The electrostatic latent image developing toner of claim 1 wherein the external particles having particle diameter of at most 2.5 μm is 5 percent or less by volume based on the external additive particles.

7. The electrostatic latent image developing toner of claim 3 wherein the external particles having particle diameter of at most 2.5 μm is 0.05-5 percent by volume based on the external additive particles.

8. The electrostatic latent image developing toner of claim 1, wherein
colored particles of at most 2.5 μm is 9 percent or less by volume based on the colored particles,
external additive particles having particle diameter of at most 2.5 μm is 0.05-5 percent by volume based on the external additive particles, and
a volume average particle diameter of the toner is 4.0-8.0 μm and sum of the colored particles and the external additive particles of at most 2.5 μm is 0.1-10 percent by volume based on the sum of the colored particles and the external additive particles.

9. An image forming method comprising steps of:
electrically charging a photoreceptor;
imagewise exposing the photoreceptor so that a latent image is formed on the photoreceptor; and
developing the latent image with toner so that a toner image is formed on the photoreceptor;
transferring the color image on the photoreceptor to a image supporting material, and
fixing the transferred color image,
wherein the method employs a toner as claimed in claim 1, and a toner image formed on an image support is fixed employing a contact heating system.

10. An image forming method comprising steps of:
electrically charging a photoreceptor;
imagewise exposing the photoreceptor so that a latent image is formed on the photoreceptor; and
developing the latent image with toner so that a toner image is formed on the photoreceptor;
transferring the color image on the photoreceptor to an intermediate transfer body,
transferring the color image on the intermediate transfer body to an image supporting material, and
fixing the transferred color image,
wherein the method employs a toner as claimed in claim 1.

11. A method of forming a toner image, comprising steps of:
(a) forming a color image on a photoreceptor by repeating steps of, employing a toner having a different color in each step:
electrically charging a photoreceptor;
imagewise exposing the photoreceptor so that a latent image is formed on the photoreceptor; and
developing the latent image with toner so that a toner image is formed on the photoreceptor;
(b) transferring the color image on the photoreceptor to a image supporting material, and
(c) fixing the transferred color image,
wherein each toner is a toner as claimed in claim 1.

12. A method of forming a toner image, comprising steps of:
(a) forming a color image on an intermediate transfer body by repeating steps of, employing a toner having a different color in each step:
electrically charging a photoreceptor;
imagewise exposing the photoreceptor so that a latent image is formed on the photoreceptor; and
developing the latent image with toner so that a toner image is formed on the photoreceptor;
transferring the toner image on the photoreceptor to the intermediate transfer body,
(b) transferring the color image on the intermediate transfer body to a image supporting material, and
(c) fixing the transferred color image on the image supporting material,
wherein each toner is a toner as claimed in claim 1.
